(19) United States
(12) Patent Application Publication
(10) Pub. No.: US 2008/0198697 A1
(43) Pub. Date: Aug. 21, 2008

(54) Analog radio-controlled timepiece

(76) Inventors: Tomoharu Tsuji, Chiba-shi (JP); Masayuki Kawata, Chiba-shi (JP); Kazumi Sakumoto, Chiba-shi (JP)

Correspondence Address: BRUCE L. ADAMS, ESQ;ADAMS & WILKS, SUITE 1231, 17 BATTERY PLACE, NEW YORK, NY, 10004, US

(21) Appl. No.: 12/012,833

(22) Filed: Feb. 6, 2008

(30) Foreign Application Priority Data
Feb. 16, 2007 (JP) 2007-036252
Feb. 16, 2007 (JP) 2007-036253
Feb. 16, 2007 (JP) 2007-036254
Jan. 9, 2008 (JP) 2008-002451

(51) Int. Cl. G04C 11/02; G04B 19/24

(52) U.S. Cl. 368/34; 368/47

(57) ABSTRACT

There is provided an analog radio-controlled timepiece made so as to be capable of performing a time difference correction by a simple operation while maintaining an operability of a time difference correction timepiece. A radio reception section receives, through an antenna, information of a minute and a second in a time code included in a standard radio, and an operation section corrects only a minute hand and a second hand to the minute and the second, which were received. A correction of an hour hand is performed by operating a crown included in a time difference correction mechanism.

### BACKGROUND OF THE INVENTION

1. Field of the Invention

The present invention relates to an analog radio-controlled timepiece receiving, by a radio, a standard radio including a time code denoting a time instant, thereby performing a time instant correction on the basis of the time code.

2. Description of the Related Art

In recent years, there becomes pervasive a radio-controlled timepiece receiving the standard radio including the time, code denoting a present time instant, thereby correcting a time instant. Further, there becomes popular a world time radio-controlled timepiece capable of receiving standard radio stations (Japan JJY40, Japan JJY60, USA WWVB, UK MSF and Germany DCF77) in the whole world (e.g., refer to JP-A-2006-153655 Gazette (Paragraphs [0030]-[0076], FIG. 1-FIG. 5)).

In the JJY40, JJY60, MSF or DCF77, a time instant data that the standard radio transmits is a local time in the actual place and, in the WWVB, it is GMT (Greenwich Mean Time; world standard time).

Therefor, depending on a receiving region, there is a case where a receiving local time (or the GMT) differs from an actual place time and, in order to realize the world time radio-controlled timepiece, it is necessary that a user inputs a time difference information in the actual place (e.g., in a case where the UK MSF is received in France, there exists a time difference of one hour).

In order to realize this, an analog radio-controlled timepiece causing the user to select his/her staying city is made a product. As to this analog radio-controlled timepiece, the world time radio-controlled timepiece is realized by calculating and displaying the actual place time by table-referring the time difference information from information of an inputted staying city.

FIG. 4 is a view showing a display part in the above conventional world time radio-controlled timepiece, and there is constituted such that, around a dial 401, there is provided a city name display part 402 in which main city names in the world are print-displayed, and a time instant display is performed by a second hand 105, a minute hand 106 and an hour hand 107, which are provided in a center part.

FIG. 5 is a block diagram of the conventional analog radio-controlled timepiece shown in FIG. 4.

In FIG. 5, the analog radio-controlled timepiece possesses an antenna 101 receiving the standard radio, a radio reception section 102 which can receive plural standard radios and extracts the time code from the standard radio received by the antenna 101 to thereby output it, an operation section 103, a selected city input section 201 for selection-inputting a city (e.g., user's staying city) whose actual place time instant is desired to be displayed, a motor 104 driven by a control signal from the operation section 103, indication hands (the second hand 105, the minute hand 106 and the hour hand 107) denoting a time instant, and drive transmission sections 110-112 for transmitting a rotation of the motor 104 to the second hand 105, the minute hand 106 and the hour hand 107.

The operation section 103 stores a time difference table in which, in regard to plural cities in the world, there is corresponded a time difference between present time instant that the standard radio outputted from each radio station denotes and the above city. Incidentally, an oscillation circuit outputting a signal of a predetermined frequency and a frequency dividing circuit frequency-dividing an output signal of the oscillation circuit to thereby output a timepiece signal clocked when the operation section 103 performs a clock operation are omitted from the depiction.

In a case where own staying city is selection-inputted, the user rotates the second hand 105 by operating the selected city input section 201 constituted by a crown or the like, thereby placing the second hand 105 to a display position of the selected city name and, by this, the selection of the city is performed.

If the standard radio is received through the antenna 101, the radio reception section 102 extracts the time code included in the standard radio and outputs it to the operation section 103.

The operation section 103 judges a standard radio station and the present time instant on the basis of the time code inputted from the radio reception section 102, judges the time difference in the city selected by the selected city input section 201 by referring to the above time difference table, corrects the time instant that the time code denotes by the time difference to thereby calculate the actual place time instant in the selected city, and rotation-controls the motor 104 so as to display the calculated actual place time instant.

The motor 104 rotation-drives the second hand 105, the minute hand 106 and the hour hand 107 through the drive transmission sections 110-112, thereby displaying the present time instant. By this, it becomes possible to display the present time instant in the user's staying place.

However, in the analog radio-controlled timepiece displaying the time instant by the time instant hands as mentioned above, in order to select the staying city, it is necessary to provide the city name display part 402 on the dial 401 or an armor, and print-display at least the typical city names in the whole world. Since the many city names must be printed in a narrow space, there is an issue that a letter becomes small and the letter is very difficult to be seen. Further, an operation causing the user to select the city name is very complicated and troublesome because the second hand must be placed to a display place of the selected city by an operation of the selected city input section 201, and thus there becomes a hindrance of the pervasiveness of the radio-controlled timepiece.

On the other, as one kind of the analog timepieces, there is utilized a time difference correction timepiece in which only the hour can be corrected by rotating only the hour hand by being separated from the second hand and the minute hand. The time difference correction timepiece has an advantage that, in a case where it is moved between the cities having the time difference, a time difference correction to the actual place time instant can be easily performed by such a simple operation as to correct only the hour hand.

### SUMMARY OF THE INVENTION

The present invention is one made in view of the above issues, and its problem is to provide an analog radio-controlled timepiece made so as to be capable of performing the time difference correction by a simple operation while maintaining an operability of the above time difference correction timepiece.

Further, a problem of the present invention is to provide an analog radio-controlled timepiece in which it is possible to perform the time difference correction and a date correction by the simple operation while maintaining the operability of the above time difference correction timepiece.

Further, a problem of the present invention is to provide an analog radio-controlled timepiece in which it is made possible to perform the time difference correction by the simple operation, and it is possible to automatically perform a date and time correction by a selection while maintaining the operability of the above time difference correction timepiece.

According to the present invention, there is provided an analog radio-controlled timepiece comprising a reception means receiving a standard radio including a time code denoting a time instant; a second hand, a minute hand and an hour hand, which analog-display a time instant; a rotation drive means rotation-driving at least the second hand, the minute hand and the hour hand; an hour hand operation means rotation-operating only the hour hand; and a control means controlling the rotation drive means so as to correct only the second hand and the minute hand to a time instant corresponding to the time code.

The control means controls the rotation drive means so as to correct only the second hand and the minute hand to the time instant corresponding to the time code.

Here, there may be constituted such that the rotation drive means has a motor and a drive transmission section for transmitting a rotation of the motor to the second hand, the minute hand and the hour hand, and the control means controls the motor and the drive transmission section so as to correct, when the reception means received the time code, only the second hand and the minute hand to the time instant corresponding to the time code.

Further, there may be constituted such that it additionally has a date indicator displaying a date, and the rotation drive means is constituted so as to rotation-drive the date indicator in response to a control of the control means; and the control means controls the rotation drive means so as to alter a displayed date of the date indicator when the hour hand became 24 o'clock by rotation-operating the hour hand by the hour hand operation means.

Further, there may be constituted such that it possesses a date indicator displaying a date, and a detection means detecting the fact that the hour hand became 24 o'clock, and the rotation drive means rotation-drives the second hand, the minute hand, the hour hand and the date indicator; and the control means controls the rotation drive means so as to perform a date unlocking processing by rotation-driving the date indicator when the detection means detected the fact that the hour hand became 24 o'clock by an operation of the hour hand operation means.

Further, there may be constituted such that the rotation drive means has a motor means and a drive transmission section for transmitting a rotation of the motor means to the second hand, the minute hand, the hour hand and the date indicator, and the control means controls the motor means and the drive transmission section so as to correct, when the reception means received the time code, only the second hand and the minute hand to a time instant corresponding to the time code.

Further, there may be constituted such that the reception means receives information of a year, a date, a minute and a second, which are included in the time code; and the control means stores the information of the year and the date, which were received by the reception means, to a storage means, and, when the detection means detected the fact that the hour hand became 24 o'clock by the operation of the hour hand operation means, controls the rotation drive means so as to perform the date unlocking processing such that a date display of the date indicator becomes a first day in a case of the end of month by referring to the information of the year and the date, which were stored in the storage means, and adds a day number date-unlocking-processed to the information stored in the storage means.

Further, there may be constituted such that it possesses a date indicator displaying a date, the rotation drive means rotation-drives the second hand, the minute hand, the hour hand and the date indicator, and the control means controls a reception mode selection means selecting one of a first reception mode in which a time instant of the second hand and the minute hand is corrected on the basis of the time code and a second reception mode in which a time of the second hand, the minute hand and the hour hand and the date of the date indicator are corrected on the basis of the time code, and the rotation drive means so as to correct, in the first reception mode, only the second hand and the minute hand to the time instant corresponding to the time code, thereby controlling the rotation drive means so as to correct, in the second reception mode, the second hand, the minute hand, the hour hand and the date indicator to a time and a date, which correspond to the time code.

Further, there may be constituted such that the rotation drive means has a motor means and a drive transmission section for transmitting a rotation of the motor means to the second hand, the minute hand, the hour hand and the date indicator, and the hour hand operation means drive-operates the drive transmission section such that only the hour hand rotates.

Further, there may be constituted such that the reception mode selection means has an operation means capable of predetermination-operating, and the control means judges, on the basis of an operation of the operation means, which of the first and second reception modes was selected, thereby controlling the rotation drive means so as to perform a processing corresponding to the selected reception mode.

Further, there may be constituted such that the operation means is constituted by the hour hand operation means, and the control means shifts to the first reception mode in a case where there was detected the fact that a time difference correction was performed by the hour hand operation means, and shifts to the second reception mode in a case where there was detected the fact that the time difference correction was released.

Further, there may be constituted such that the hour hand operation means includes a crown and performs the time difference correction of the hour hand by an operation of the crown, and the control means shifts to the first reception mode in the case where there was detected the fact that the time difference correction was performed by the crown, and shifts to the second reception mode in the case where there was detected the fact that the time difference correction was released.

Further, there may be constituted such that it has a detection means detecting the fact that the hour hand became 24 o'clock, and the control means controls the rotation drive means so as to perform a date unlocking processing by rotation-driving the date indicator when the detection means detected the fact that the hour hand became 24 o'clock by an operation of the hour hand operation means.

Further, there may be constituted such that the reception means receives, in the first reception mode, only information of a minute and a second, which are included in the time code.

Further, there may be constituted such that the hour hand operation means drive-controls the drive transmission section such that only the hour hand rotates.

Further, there maybe constituted such that the reception means receives only information of a second and a minute, which are included in the time code.

Further, there may be constituted such that the control means controls, in a case correcting the second hand and the minute hand, the rotation drive means so as to rotate the second hand and the minute hand in a direction in which the correction quickly ends, in compliance with positions of the second hand and the minute hand.

According to the analog radio-controlled timepiece concerned with the present invention, it becomes possible to perform the time difference correction by the simple operation while maintaining the operability of the time difference correction timepiece.

Further, according to the analog radio-controlled timepiece concerned with the present invention, it becomes possible to perform the time difference correction and the date correction by the simple operation while maintaining the operability of the time difference correction timepiece.

Further, according to the analog radio-controlled timepiece concerned with the present invention, it becomes possible to perform the time difference correction by the simple operation while maintaining the operability of the time difference correction timepiece, and it becomes also possible to automatically perform the date and time correction by the selection.

### BRIEF DESCRIPTION OF THE DRAWINGS

FIG. 1 is a block diagram of an analog radio-controlled timepiece concerned with a first embodiment of the present invention;

FIG. 2 is a flowchart showing processings in the analog radio-controlled timepiece concerned with each embodiment of the present invention;

FIG. 3 is a block diagram of an analog radio-controlled timepiece concerned with a second embodiment of the present invention;

FIG. 4 is an external appearance view of a conventional analog radio-controlled timepiece;

FIG. 5 is a block diagram of the conventional analog radio-controlled timepiece;

FIG. 6 is a block diagram of an analog radio-controlled timepiece concerned with a third embodiment of the present invention;

FIG. 7 is a flowchart showing processings in an analog radio-controlled timepiece concerned with a fourth embodiment of the present invention;

FIG. 8 is a flowchart showing processings in the analog radio-controlled timepiece concerned with the fourth embodiment of the present invention;

FIG. 9 is a block diagram of an analog radio-controlled timepiece concerned with a fifth embodiment of the present invention;

FIG. 10 is a flowchart showing processings in the analog radio-controlled timepiece concerned with the fifth embodiment of the present invention; and

FIG. 11 is a flowchart showing processings in the analog radio-controlled timepiece concerned with the fifth embodiment of the present invention.

### DETAILED DESCRIPTION OF THE INVENTION

Hereunder, there is explained about an analog radio-controlled timepiece concerned with each of the embodiments of the present invention. Incidentally, in each drawing, the same reference numeral is applied to the same portion.

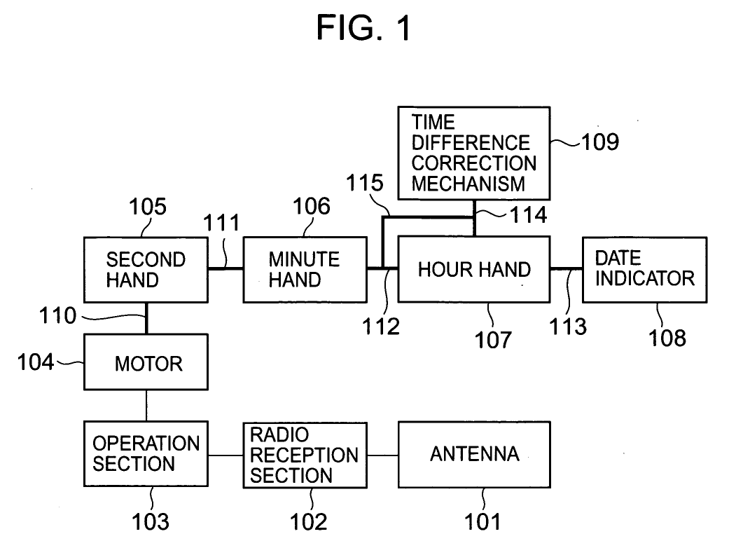

FIG. 1 is a block diagram of an analog radio-controlled timepiece concerned with a first embodiment of the present invention, and shows an example of a wristwatch type analog radio-controlled timepiece.

In FIG. 1, the analog radio-controlled timepiece possesses the antenna 101 receiving the standard radio, the radio reception section 102 which can receive the standard radios of plural frequencies and extracts the time code from the standard radio received by the antenna 101 to thereby output it, the operation section 103 constituted by a central processing unit (CPU) and a memory storing a program that the CPU implements, the motor 104 driven by the control signal from the operation section 103, the indication hands (the second hand 105, the minute hand 106 and the hour hand 107) denoting the time instant, and a date indicator 108.

Further, the analog radio-controlled timepiece possesses drive transmission sections 110-113 for transmitting the rotation of the motor 104 to the second hand 105, the minute hand 106, the hour hand 107 and the date indicator 108, a time difference correction mechanism 109 performing a time difference correction by rotation-operating only the hour hand 107, a drive transmission section 114 transmitting an operation of the time difference correction mechanism 109 to the hour hand 107 to thereby rotate the hour hand, and a rotation prevention mechanism 115 regulating a motion of the drive transmission section 112 such that the second hand 105 and the minute hand 106 are not rotated by the operation of the time difference correction mechanism 109.

The time difference correction mechanism 109 is a mechanism used in the time difference correction timepiece publicly known and has a crown (not shown in the drawing), and it is constituted so as to be capable of rotation-operating only the hour hand 107 by the fact that the user operates the crown.

Incidentally, there may be constituted so as to rotation-drive the date indicator 108 by a motor different from the motor 104.

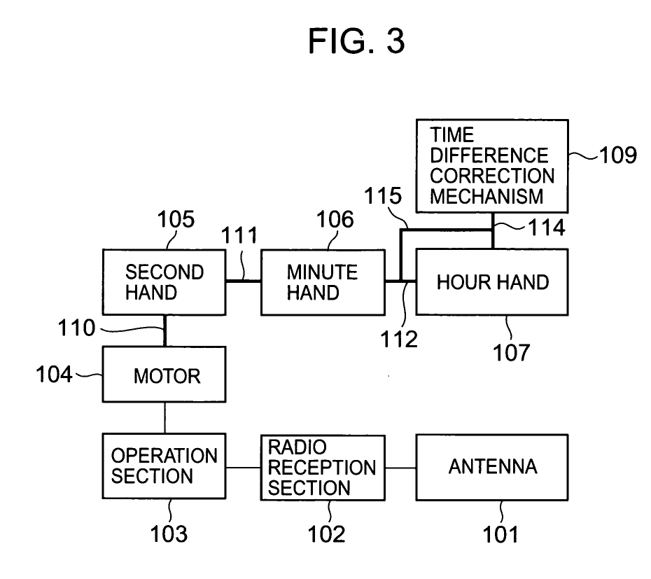

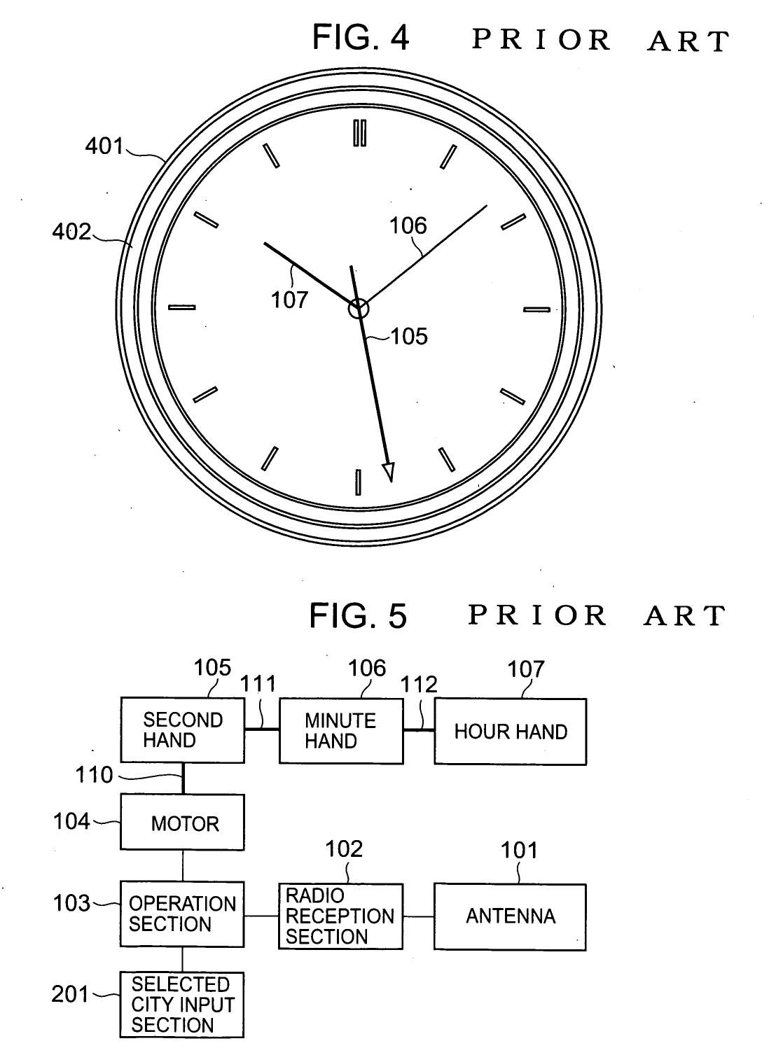

Further, since there is no direct relation with a characteristic portion of the present first embodiment, there is omitted a circuit constitution portion for the fact that the operation section 103 performs an ordinary clock operation (functions as a clock means). That is, although not shown clearly in FIG. 1 and FIG. 3, similarly to an ordinary radio-controlled timepiece, it possesses an oscillation circuit outputting a signal of a predetermined frequency, and a frequency dividing circuit frequency-dividing an output signal of the oscillation circuit, thereby outputting a timepiece signal that the operation section 103 clocks when performing a clock operation.

Incidentally, the antenna 101 and the radio reception section 102 constitute a reception means receiving the standard radio, the time difference correction mechanism 109 constitutes an hour hand operation means, the motor 104 and the drive transmission sections 110-114 and the rotation prevention mechanism 115 constitute a rotation drive means, and the operation section 103 constitutes a control means. As the standard radio to be received, although there suffices if at least one exists, in a case where the standard radios from plural standard radio stations, whose frequencies or time code forms differ, are received and used, there suffices if the antenna 101 and the radio reception section 102 are made so as to constitute the reception means capable of receiving the standard radios from the plural standard radio stations.

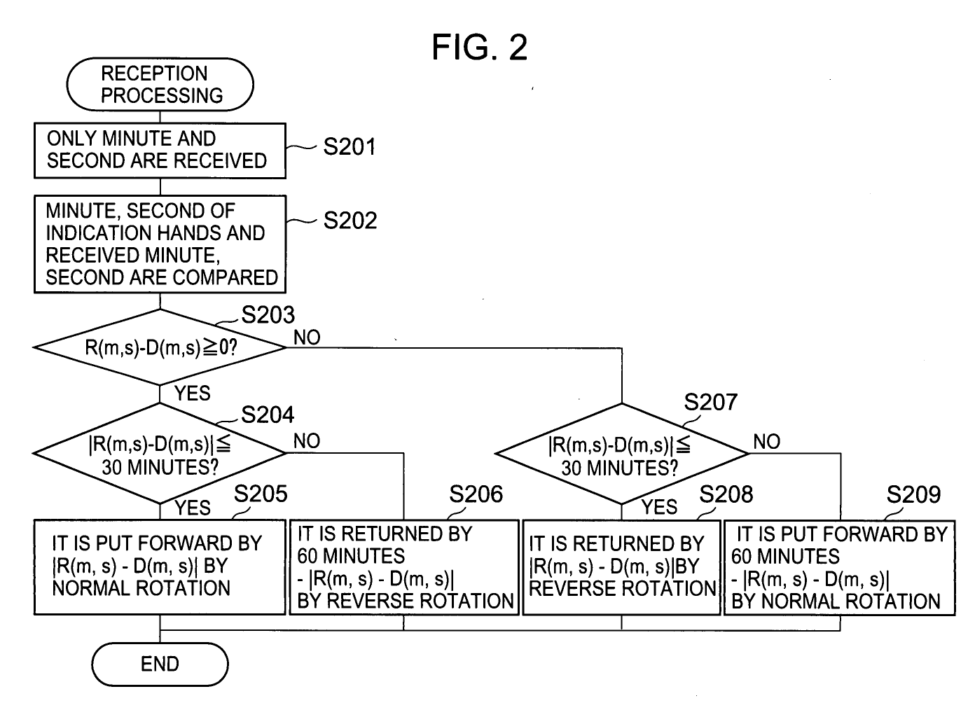

FIG. 2 is a flowchart showing processings in the analog radio-controlled timepiece concerned with the first embodiment of the present invention, and shows mainly processings in the operation section 103.

Hereunder, by using FIG. 1 and FIG. 2, there are detailedly explained operations in the analog radio-controlled timepiece concerned with the first embodiment of the present invention.

The radio reception section 102 receives the standard radio through the antenna 101. In a standard radio signal, although there is included the time code denoting a year, a month, a date, an hour, a minute and a second, the operation section 103 controls the radio reception section 102 so as to receive only information relating to the minute and the second in the time code included in the standard radio signal (a step S201). At this time, although there may be constituted so as to receive the whole time code, since there is made so as to receive only the necessary information in the time code, it is possible to shorten a reception time, and further it is possible to save an electric power.

Next, the operation section 103 compares a large/small relation between [the minute and the second (D (m, s)) during *being displayed by the indication hands (the minute hand 106 and the second hand 105)] and [the minute and the second (R (m, s)) in the received time code] (steps S202 and S203).

In a case where it was judged in the processing step S203 that (R (m, s)−(D (m, s))≧0, i.e., in a case where it was judged that the minute and the second in the time code were faster than the minute and the second during being displayed, the operation section 103 judges whether or not an absolute value of (R (m, s)−D (m, s)) is 30 minutes or less (a step S204) and, in a case where it is less than 30 minutes, rotation-controls the motor 104 such that the minute hand 106 and the second hand 105 rotate by for the absolute value of (R (m, s)−D (m, s)) in a normal rotation (clockwise) direction, thereby performing a time instant correction of the minute and the second (a step S205).

In a case where it was judged in the processing step S204 that the absolute value of (R (m, s)−D (m, s)) was not less than 30 minutes, the operation section 103 rotation-controls the motor 104 so as to rotate the minute hand 106 and the second hand 105 by for an absolute value of (60 minutes−R (m, s)−D (m, s)) in a reverse rotation (counterclockwise) direction, thereby performing the time instant correction of the minute and the second (a step S206).

On the other hand, in a case where it was judged in the processing step S203 that there was not (R (m, s)−(D (m, s))≧0, i.e., in a case where it was judged that the minute and the second during being displayed were faster than the minute and the second in the time code, the operation section 103 judges whether or not the absolute value of (R (m, s)−D (m, s)) is 30 minutes or less (a step S207) and, in the case where it is less than 30 minutes, rotation-controls the motor 104 such that the minute hand 106 and the second hand 105 rotate by for the absolute value of (R (m, s)−D (m, s)) in the reverse rotation (counterclockwise) direction, thereby performing the time instant correction of the minute and the second (a step S208).

In a case where it was judged in the processing step S207 that the absolute value of (R (m, s)−D (m, s)) was not less than 30 minutes, the operation section 103 rotation-controls the motor 104 so as to rotate the minute hand 106 and the second hand 105 by for the absolute value of (60 minutes−R (m, s)−(m, s)) in the normal rotation (clockwise) direction, thereby performing the time instant correction of the minute and the second (a step S209).

Like the processing steps S202-S209, the operation section 103 controls, when correcting to second information, a movement quantity so as to become within ±30 minutes by for the obtained time code. That is, in a case where the second hand 105 and the minute hand 106 are time-instant-corrected, since the operation section 103 controls the motor 104 so as to rotate the second hand 105 and the minute hand 106 in compliance with positions of the second hand 105 and the minute hand 106 in a direction in which the correction quickly ends, it becomes possible to perform the time instant correction of the second hand 105 and the minute hand in a short time.

In a case where the hour hand 107 is corrected by an operation of the time difference correction mechanism 109, if there is performed a predetermined operation such as rotation-operating a crown included in the time difference correction mechanism 109 by being stage-pulled, the predetermined operation is transmitted to the hour hand through the transmission section 114 for the time difference correction and a time difference correction of the hour hand 107 is performed. At this time, since the operation of the time difference correction mechanism 109 is not transmitted to the drive transmission section 112 by the rotation prevention mechanism 115, the second hand 105 and the minute hand 106 don't rotate, so that the correction of only the hour hand 107 is performed.

Further, when the hour hand 107 became 24 o'clock by the operation of the time difference correction mechanism 109, the operation section 103 rotation-controls the motor 104 such that a displayed date of the date indicator 108 becomes next day. The motor 104 rotation-drives the date indicator 108 through the transmission section 113, thereby altering a date display.

As mentioned above, according to the analog radio-controlled timepiece concerned with the present embodiment, by the fact that there is constituted such that the second hand 105 and the minute hand 106 are corrected on the basis of the standard radio and the user sets the hour hand 107 and the date indicator 108, it becomes possible to provide an analog radio-controlled timepiece whose operation becomes very simple, and in which the standard radio stations in the whole world can be received while maintaining the operability of the time difference correction timepiece.

Incidentally, as to the standard radio station capable of being received, even if it is not one in the whole world, there suffices if the time instant correction can be performed by receiving the standard radio of the standard radio station in a region of one part.

Further, as shown in FIG. 3, as a second embodiment of the present invention, there can be made a constitution in which the date indicator 108 is omitted. Operations in the present second embodiment are the same as the above first embodiment apart from the operations relating to the date indicator 108 and, also about the reception processings, there are performed the reception processings written in FIG. 2.

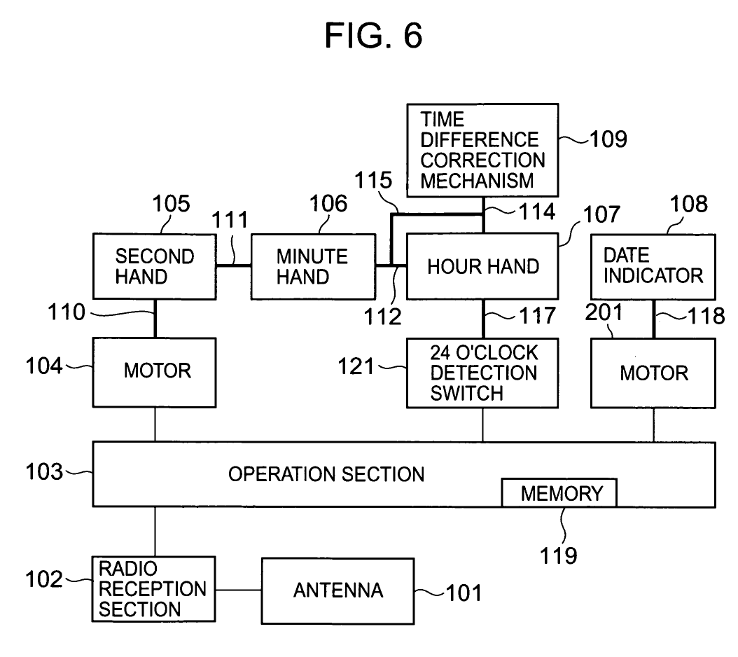

FIG. 6 is a block diagram of an analog radio-controlled timepiece concerned with a third embodiment of the present invention, and a block diagram common to embodiments mentioned later, and shows the example of the wristwatch type analog radio-controlled timepiece.

In FIG. 6, the analog radio-controlled timepiece possesses the antenna 101 receiving the standard radio, the radio reception section 102 which can receive the standard radios of plural frequencies and extracts the time code from the standard radio received by the antenna 101 to thereby output it, the operation section 103 constituted by the central processing unit (CPU) and a memory 119 storing the program that the CPU implements, the first motor 104 for driving the indication hands, which is driven by the control signal from the operation section 103, and a second motor 201 for driving the date indicator, the indication hands (the second hand 105, the minute hand 106 and the hour hand 107) denoting the time instant, and the date indicator 108. Incidentally, in a fourth embodiment mentioned later, there is constituted such that information of a year and a date in the received time code can be stored in the memory 119.

Further, the analog radio-controlled timepiece possesses the drive transmission sections 110-112 for transmitting the rotation of the first motor 104 to the second hand 105, the minute hand 106 and the hour hand 107, which are constituted by train wheels for instance, a drive transmission section 118 for transmitting a rotation of the second motor 201 to the date indicator 108, the time difference correction mechanism 109 performing the time difference correction by rotation-operating only the hour hand 107, the drive, transmission section 114 transmitting the operation of the time difference correction mechanism 109 to the hour hand 107 to thereby rotate the hour hand 107, the rotation prevention mechanism 115 regulating the motion of the drive transmission section 114 such that the second hand 105 and the minute hand 106 are not rotated by the operation of the time difference correction mechanism 109, a 24 o'clock detection switch 121 detecting the fact that the hour hand 107 became 24 o'clock by an operation of the time difference correction mechanism 109, and a drive transmission section 117 transmitting (e.g., the 24 o'clock detection switch 121 is made ON) the fact that the hour hand 107 became 24 o'clock by the operation of the time difference correction mechanism 109 to the 24 o'clock detection switch 121.

The time difference correction mechanism 109 is the mechanism used in the time difference correction timepiece publicly known and has the crown (not shown in the drawing), and it is constituted so as to be capable of rotation-operating only the hour hand 107 by the fact that the user operates the crown.

Incidentally, it is not always necessary to provide plural motors of the first motor 104 for driving the indication hands and the second motor 201 for driving the date indicator 108, and there may be constituted such that at least one motor 104 is provided and the date indicator 108 is rotation-driven by the motor 104.

Further, since there is no direct relation with a characteristic portion of the present third embodiment, there is omitted the circuit constitution portion for the fact that the operation section 103 performs the ordinary clock operation (functions as the clock means). That is, although not shown clearly in FIG. 6, similarly to the ordinary radio-controlled timepiece, it possesses the oscillation circuit outputting the signal of the predetermined frequency, and the frequency dividing circuit frequency-dividing the output signal of the oscillation circuit, thereby outputting the timepiece signal that the operation section 103 clocks when performing the clock operation.

Incidentally, the antenna 101 and the radio reception section 102 constitute the reception means receiving the standard radio, the time difference correction mechanism 109 constitutes the hour hand operation means, the first motor 104, the second motor 201, the drive transmission sections 110-112, 114, 117, 118 and the rotation prevention mechanism 115 constitute the rotation drive means, the 24 o'clock detection switch 121 constitutes a detection means, the operation section 103 constitutes the control means, and the memory 119 constitutes a storage means. Further, the first motor 104 and the second motor 201 constitute a motor means. As the standard radio to be received, although there suffices if at least one exists, in the case where the standard radios from plural standard radio stations, in which their frequencies or time code forms differ, are received and used, there suffices if the antenna 101 and the radio reception section 102 are made so as to constitute the reception means capable of receiving the standard radios from the plural standard radio stations.

In the analog radio-controlled timepiece concerned with the third embodiment of the present invention, there are performed the same reception processings as the flowchart of FIG. 2.

Hereunder, by using FIG. 6 and FIG. 2, there are detailedly explained operations in the analog radio-controlled timepiece concerned with the third embodiment of the present invention.

In FIG. 6 and FIG. 2, there are explained processings in a case where the correction of the minute and the second is performed by receiving only information of the minute and the second in the time code included in the standard radio signal.

The radio reception section 102 receives the standard radio through the antenna 101. In the standard radio signal, although there is included the time code denoting the year, the date, the hour, the minute and the second, the operation section 103 controls, on the basis of information in the time code inputted from the radio reception section 102, the radio reception section 102 so as to receive only information relating to the minute and the second in the time code included in the standard radio signal (the step S201). At this time, although there may be constituted so as to receive the whole time code, since there is made so as to receive only the necessary information in the time code, it is possible to shorten the reception time, and further it is possible to save the electric power.

Next, the operation section 103 compares the large/small relation between [the minute and the second (D (m, s)) during being displayed by the indication hands (the minute hand 106 and the second hand 105)] and [the minute and the second (R (m, s)) in the received time code] (the steps S202 and S203).

In the case where it was judged in the processing step S203 that (R (m, s)−(D (m, s))≧0, i.e., in the case where it was judged that the minute and the second in the time code were faster than the minute and the second during being displayed, the operation section 103 judges whether or not the absolute value of (R (m, s)−D (m, s)) is 30 minutes or less (the step S204) and, in the case where it is less than 30 minutes, rotation-controls the first motor 104 such that the minute hand 106 and the second hand 105 rotate by for the absolute value of (R (m, s)−D (m, s)) in the normal rotation (clockwise) direction, thereby performing the time instant correction of the minute and the second (the step S205).

In the case where it was judged in the processing step S204 that the absolute value of (R (m, s)−D (m, s)) was not less than 30 minutes, the operation section 103 rotation-controls the first motor 104 so as to rotate the minute hand 106 and the second hand 105 by for the absolute value of (60 minutes−R (m, s)−D (m, s)) in the reverse rotation (counterclockwise) direction, thereby performing the time instant correction of the minute and the second (the step S206).

On the other hand, in the case where it was judged in the processing step S203 that there was not (R (m, s)−(R (m, s))≧0, i.e., in the case where it was judged that the minute and the second during being displayed were faster than the minute and the second in the time code, the operation section 103 judges whether or not the absolute value of (R (m, s)−D (m, s)) is 30 minutes or less (the step S207) and, in the case where it is less than 30 minutes, rotation-controls the first motor 104 such that the minute hand 106 and the second hand 105 rotate by for the absolute value of (R (m, s)−D (m, s)) in the reverse rotation (counterclockwise) direction, thereby performing the time instant correction of the minute and the second (the step S208).

In the case where it was judged in the processing step S207 that the absolute value of (R (m, s)−D (m, s)) was not less than 30 minutes, the operation section 103 rotation-controls the first motor 104 so as to rotate the minute hand 106 and the second hand 105 by for the absolute value of (60 minutes−R (m, s)−D (m, s)) in the normal rotation (clockwise) direction, thereby performing the time instant correction of the minute and the second (the step S209).

Like the processing steps S202-S209, the operation section 103 controls, when correcting to the second information, the movement quantity so as to become within ±30 minutes by for the obtained time code. That is, in the case where the second hand 105 and the minute hand 106 are time-instant-corrected, since the operation section 103 controls the first motor 104 so as to rotate the second hand 105 and the minute hand 106 in compliance with positions of the second hand 105 and the minute hand 106 in the direction in which the correction quickly ends, it becomes possible to perform the time instant correction of the second hand 105 and the minute hand 106 in the short time.

In the case where the hour hand 107 is corrected by the operation of the time difference correction mechanism 109, if there is performed the predetermined operation such as rotation-operating the crown included in the time difference correction mechanism 109 by being stage-pulled, the predetermined operation is transmitted to the hour hand 107 through the transmission section 114 for the time difference correction and the time difference correction of the hour hand 107 is performed. At this time, since the operation of the time difference correction mechanism 109 is not transmitted to the drive transmission section 112 by the rotation prevention mechanism 115, the second hand 105 and the minute hand 106 don't rotate, so that the correction of only the hour hand 107 is performed.

Further, by the operation of the time difference correction mechanism 109, if the fact that the hour hand 107 became 24 o'clock is transmitted to the 24 o'clock detection switch 121 through the drive transmission section 117, the 24 o'clock detection switch 121 detects the fact the hour hand 107 became 24 o'clock. If the 24 o'clock detection switch 121 detects the fact that the hour hand 107 became 24, the operation section 103 rotation-controls the second motor 201 so as to date-unlocking-process the displayed date of the date indicator 108. The second motor 201 rotation-drives the date indicator 108 through the drive transmission section 118, thereby altering a date display to next day.

In this manner, according to the present third embodiment, by the fact that there is constituted such that the second hand 105 and the minute hand 106 are corrected on the basis of the standard radio and the user sets the hour hand 107 and the date indicator 108, it becomes possible to provide the analog radio-controlled timepiece whose operation becomes very simple, and in which the standard radio stations in the whole world can be received while maintaining the operability of the time difference correction timepiece.

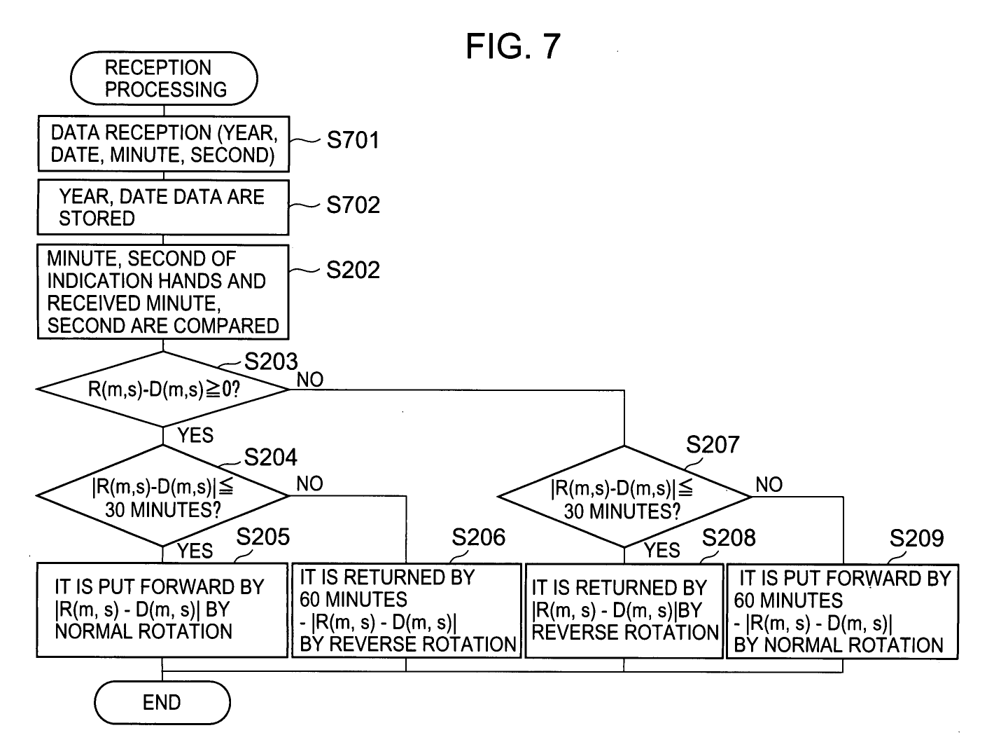

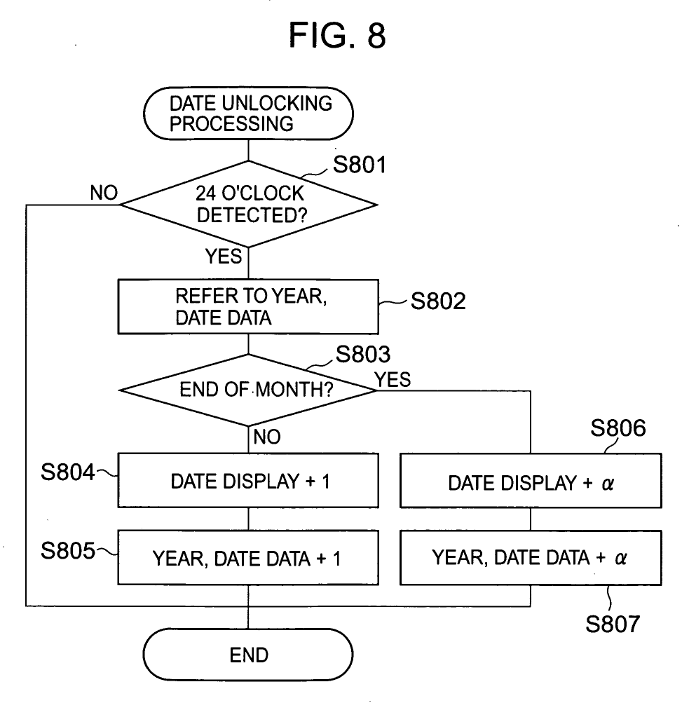

FIG. 7 and FIG. 8 are flowcharts showing processings in an analog radio-controlled timepiece concerned with a fourth embodiment of the present invention, and show mainly processings in the operation section 103.

In FIG. 7, there are shown processings in a case where there is made such that the correction of the minute and the second is performed by receiving only information of the year, the date, the minute and the second in the time code included in the standard radio signal and, for the date correction, the information of the year and the date are stored in the memory 119, and the same sign is applied to a portion performing the same processing as FIG. 2.

Further, in FIG. 8, there is shown an example in which, in a case where the 24 o'clock detection switch 121 detected the fact that the hour hand 107 became 24 o'clock, a date unlocking processing of the date indicator 108 is suitably performed in compliance with whether or not a date in question is the end of month, on the basis of the information of the year and the date, which were stored in the memory 119.

First, by using FIG. 6 and FIG. 7, there are explained processings in a case where the correction of the minute and the second is performed by receiving only the information of the year, the date, the minute and the second in the time code included in the standard radio signal and, for the date correction, the information of the year and the date are stored in the memory 119 of the operation section 103.

The radio reception section 102 receives the standard radio through the antenna 101. In the standard radio signal, although there is included the time code denoting the year, the date, the hour, the minute and the second, the operation section 103 controls, on the basis of information in the time code inputted from the radio reception section 102, the radio reception section 102 so as to receive only information relating to the year, the date, the minute and the second in the time code included in the standard radio signal (a step S701). At this time, although there may be constituted so as to receive the whole time code, since there is made so as to receive only the necessary information in the time code, it is possible to shorten the reception time, and further it is possible to save the electric power.

Next, the operation section 103 stores the information of the year and the date in the time code to the memory 119 in an inside of the operation section 103 (a step S702).

Hereafter, similarly to FIG. 2, the operation section 103 compares the large/small relation between [the minute and the second (D (m, s)) during being displayed by the indication hands (the minute hand 106 and the second hand 105)] and [the minute and the second (R (m, s)) in the received time code], and controls the motor 104 so as to rotate the second hand 105 and the minute hand 106 in the direction in which the correction quickly ends (the steps S202-S209).

Next, by using FIG. 6 and FIG. 8, there are explained operations when performing the date unlocking processing of the date indicator 108 in the case where the 24 o'clock detection switch 121 detected the fact that the hour hand 107 became 24 o'clock.

If it is judged that the 24 o'clock detection switch 121 detected the fact that the hour hand 107 became 24 o'clock (a step S801), the operation section 103 refers to the information of the year and the date, which are stored in the memory 119 (a step S802), thereby judging whether or not today is the end of month (a step S803).

If it is judged in the processing step S803 that today is not the end of month, the operation section 103 controls the second motor 201 so as to increase, by one day, the date display of the date indicator 108 (a step S804), thereby adding one day to the information of the year and the date, which are stored in the memory 119 (a step S805) In response to the control of the operation section 103, the second motor 201 rotation-drives, for one day, the date indicator 108 through the drive transmission section 118, thereby altering the date display to next day.

On the other hand, if it is judged in the processing step S803 that today is the end of month, the operation section 103 controls the second motor 201 so as to increase the date display by a predetermined date number a day in compliance with a month such that the date display of the date indicator 108 becomes a first day of next month (a step S806), and adds the above predetermined date number a day to the information of the year and the date, which are stored in the memory 119 (a step S807). In response to the control of the operation section 103, the second motor 201 rotation-drives, by for the above predetermined date number a day, the date indicator 108 through the drive transmission section 118, thereby altering the date display to the first day of next month.

As mentioned above, according to the analog radio-controlled timepiece concerned with the present fourth embodiment, similarly to the above third embodiment, by the fact that there is constituted such that the second hand 105 and the minute hand 106 are corrected on the basis of the standard radio and the user sets the hour hand 107 and the date indicator 108, it becomes possible to provide the analog radio-controlled timepiece whose operation becomes very simple, and in which the standard radio stations in the whole world can be received while maintaining the operability of the time difference correction time piece. Further, in a case where the date changes when performing the time difference correction, it becomes possible to perform a suitable date unlocking processing in compliance with whether or not it is the end of month.

Incidentally, as to the standard radio station capable of being received, even if it is not one in the whole world, there suffices if the time instant correction can be performed by receiving the standard radio of the standard radio station in the region of one part.

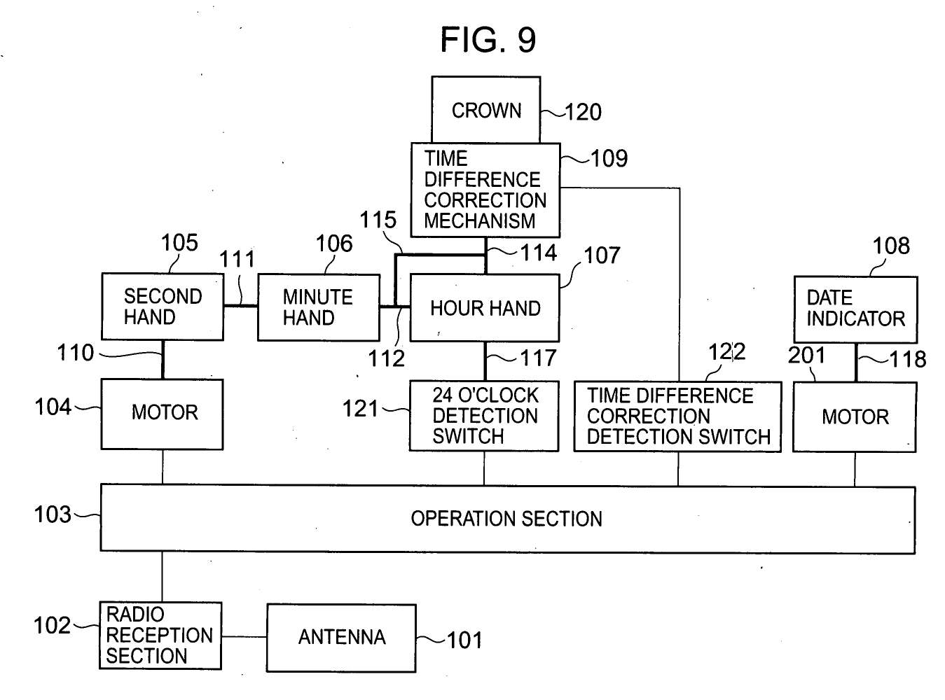

FIG. 9 is a block diagram of an analog radio-controlled timepiece concerned with a fifth embodiment of the present invention, and shows the example of the wristwatch type analog radio-controlled timepiece. In FIG. 9, the analog radio-controlled timepiece possesses the antenna 101 receiving the standard radio, the radio reception section 102 which can receive the standard radios of plural frequencies and extracts the time code from the standard radio received by the antenna 101 to thereby output it, the operation section 103 constituted by the central processing unit (CPU) and a memory (not shown in the drawing) storing the program that the CPU implements, the first motor 104 for driving the indication hands, which is driven by the control signal from the operation section 103, and the second motor 201 for driving the date indicator, the indication hands (the second hand 105, the minute hand 106 and the hour hand 107) denoting the time instant, and the date indicator 108.

Further, the analog radio-controlled timepiece possesses the drive transmission sections 110-112 for transmitting the rotation of the first motor 104 to the second hand 105, the minute hand 106 and the hour hand 107, the drive transmission section 118 for transmitting the rotation of the second motor 201 to the date indicator 108, the time difference correction mechanism 109 performing the time difference correction by rotation-operating only the hour hand 107, the drive transmission section 114 transmitting the operation of the time difference correction mechanism 109 to the hour hand 107 to thereby rotate the hour hand 107, the rotation prevention mechanism 115 regulating the motion of the drive transmission section 112 such that the second hand 105 and the minute hand 106 are not rotated by the operation of the time difference correction mechanism 109, the 24 o'clock detection switch 121 detecting the fact that the hour hand 107 became 24 o'clock by the operation of the time difference correction mechanism 109, the drive transmission section 117 transmitting (e.g., the 24 o'clock detection switch 121 is made ON) the fact that the hour hand 107 became 24 o'clock by the operation of the time difference correction mechanism 109 to the 24 o'clock detection switch 121, and a time difference correction detection switch 122 detecting whether or not the time difference correction of the hour hand 107 was performed by the operation (e.g., a predetermined operation of a crown 120 included in the time difference correction mechanism 109) of the time difference correction mechanism 109. Each of the drive transmission sections 110-112, 114, 117, 118 can be constituted by a train wheel.

The time difference correction mechanism 109 is the mechanism used in the time difference correction timepiece publicly known and has the crown 120 that the user can operate, and it is constituted so as to be capable of rotation-operating only the hour hand 107 by the fact that the user operates the crown 120.

Incidentally, it is not always necessary to provide plural motors of the first motor 104 for driving the indication hands and the second motor 201 for driving the date indicator 108, and there may be constituted such that at least one motor 104 is provided, and the indication hands 105-107 and the date indicator 108 are rotation-driven by the motor 104.

Further, since there is no direct relation with a characteristic portion of the present fifth embodiment, there is omitted the circuit constitution portion for the fact that the operation section 103 performs the ordinary clock operation (functions as the clock means). That is, although not shown clearly in FIG. 9, similarly to the ordinary radio-controlled timepiece, it possesses the oscillation circuit outputting the signal of the predetermined frequency, and the frequency dividing circuit frequency-dividing the output signal of the oscillation circuit, thereby outputting the timepiece signal that the operation section 103 clocks when performing the clock operation.

Here, the antenna 101 and the radio reception section 102 constitute the reception means receiving the standard radio, and the time difference correction mechanism 109 constitutes the hour hand operation means and an operation means. The first motor 104, the second motor 201, the drive transmission sections 110-112, 114, 117, 118 and the rotation prevention mechanism 115 constitute the rotation drive means, the 24 o'clock detection switch 121 constitutes the detection means, and the operation section 103 constitutes the control means. The first motor 104 and the second motor 201 constitute the motor means.

Further, the time difference correction mechanism 109, the time difference correction detection switch 122 and the operation section 103 constitute a reception mode selection means. Incidentally, there may be constituted such that the reception mode selection means automatically shifts to a first reception mode or a second reception mode when there is satisfied a reception environment in which reception sensitivity is higher than a predetermined level, or such a predetermined condition that the present time instant is a predetermined time instant.

As the standard radio capable of being received, although there suffices if at least one exists, in a case where the standard radios from plural standard radio stations, whose frequencies or time code forms differ, are received and used, there suffices if there is made such that the antenna 101 and the radio reception section 102 constitute the reception means capable of receiving the standard radios from the plural standard radio stations.

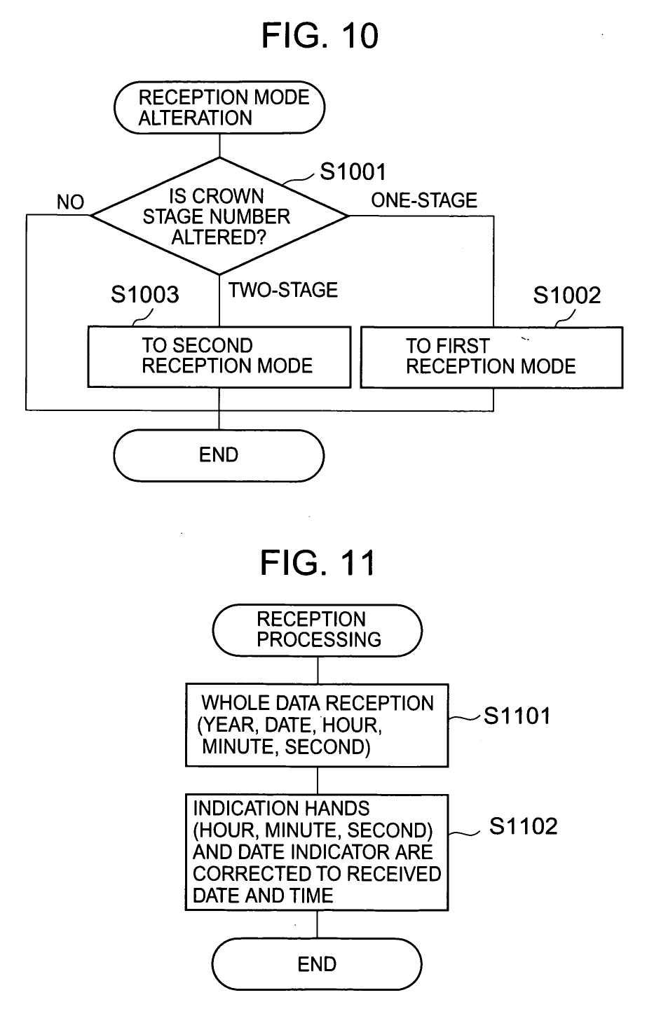

FIG. 10 is a flowchart showing processings in the analog radio-controlled timepiece concerned with the fifth embodiment of the present invention, and shows mainly processings in the operation section 103. In FIG. 10, processings for selecting the reception mode are shown.

In explaining selection processings in the reception mode by using FIG. 9 and FIG. 10, the operation section 103 judges whether or not the time difference correction mechanism 109 was operated, concretely whether or not the crown 120 included in the time difference correction mechanism 109 was operated (a step S1001).

When it was judged in the processing step S1001 that the crown 120 was one-stage-pull-operated, the operation section 103 shifts to the first reception mode in which the time instant of only the second hand 105 and the minute hand 106 is corrected on the basis of the time code of the standard radio received by the radio reception section 102 (a step S1002) and, when it was judged that the crown 120 was two-stage-pull-operated, it shifts to the second reception mode in which the time and the date of the second hand 105, the minute hand 106, the hour hand 107 and the date indicator 108 are corrected on the basis of the above time code (a step S1003) and, when the crown is not operated like the above, it does not shift to the above reception modes.

Incidentally, in the present fifth embodiment, since there is constituted such that the time difference correction of the hour hand 107 can be performed in the case where the crown 120 was one-stage-pulled, the time difference correction detection switch 122 detects the fact that the crown 120 was one-stage-pulled (in other words, the time difference correction was performed), and performs a notification to the effect that the time difference correction was performed to the operation section 103. The operation section 103 receives the above notification from the time difference correction detection switch 122, and judges that a time difference correction operation was performed.

On the other hand, since there is constituted such that, in the case where the crown 120 was two-stage-pulled, the time difference correction of the hour hand 107 is released and thus the time difference correction cannot be performed, the time difference correction detection switch 122 detects the fact that the crown 120 was two-stage-pulled (in other words, the time difference correction was released), and notifies a time difference correction release to the operation section 103. The operation section 103 receives the above notification from the time difference correction detection switch 122, and judges that a time difference correction release operation was performed.

FIG. 11 shows processings in the operation section 103 in the above second reception mode. They are processings in a case where the whole information (concretely, the year, the date, the hour, the minute and the second) of the time code included in the standard radio signal are received, thereby performing the corrections of the date and the time, and processings similar to the time instant correction processings that the general radio-controlled timepiece ordinarily performs.

Hereunder, by using FIG. 9 and FIG. 11, there are schematically explained operations in the second reception mode of the analog radio-controlled timepiece concerned with the fifth embodiment of the present invention.

Incidentally, since the processings in the first reception mode of the analog radio-controlled timepiece concerned with the present fifth embodiment are the same as FIG. 2, their explanations are omitted.

The radio reception section 102 receives the standard radio through the antenna 101. At this time, the operation section 103 judges the fact that it is the second reception mode, and controls the radio reception section 102 so as to receive the whole information (concretely, the year, the date, the hour, the minute and the second) included in the time code of the standard radio (a step S1101).

Next, the operation section 103 controls, on the basis of the date and time information (the year, the date, the hour, the minute and the second) of the received time code, the first motor 104 and the second motor 201 so as to correct the displayed time instant of the indication hands (the second hand 105, the minute hand 106 and the hour hand 107) and the displayed date of the date indicator 108 (a step S1102). The first motor 104 and the second motor 201 respectively correct the indication hands 105-107 and the date indicator 108 so as to coincide with the received time code, thereby finishing the date and time correction.

As mentioned above, according to the analog radio-controlled timepiece concerned with the present fifth embodiment, there is constituted so as to be capable of selecting the first reception mode in which the second hand 105 and the minute hand 106 are automatically time-instant-corrected and the hour hand 107 is time-difference-corrected by a manual motion, and the second reception mode in which the indication hands 105-107 and the date indicator 108 are automatically corrected.

Accordingly, in the first reception mode, by the fact that there is constituted such that the second hand 105 and the minute hand 106 are corrected on the basis of the standard radio and the user sets the hour hand 107 and the date indicator 108, it becomes possible to provide the analog radio-controlled timepiece whose operation becomes very simple, and in which the standard radio stations in the whole world can be received while maintaining the operability of the time difference correction timepiece.

Further, in the second reception mode, it becomes possible to automatically perform the time instant correction without performing any operation.

Therefore, there are brought about such advantages that it becomes possible to perform the time difference correction by the simple operation while maintaining the operability of the time difference correction timepiece, and that it becomes also possible to automatically perform the date and time correction by the selection.

Incidentally, as to the standard radio station capable of being received, even if it is not one in the whole world, there suffices if the time instant correction can be performed by receiving the standard radio of the standard radio station in the region of one part.

The present invention can be utilized in the analog radio-controlled timepiece capable of receiving the standard radio(s) that one or plural standard radio station(s) transmits or transmit.

What is claimed is:

1. An analog radio-controlled timepiece comprising:
a reception means receiving a standard radio including a time code denoting a time instant;
a second hand, a minute hand and an hour hand, which analog-display a time instant;
a rotation drive means rotation-driving at least the second hand, the minute hand and the hour hand;
an hour hand operation means rotation-operating only the hour hand; and
a control means controlling the rotation drive means so as to correct only the second hand and the minute hand to a time instant corresponding to the time code.

2. An analog radio-controlled timepiece according to claim 1, wherein:
the rotation drive means has a motor and a drive transmission section for transmitting a rotation of the motor to the second hand, the minute hand and the hour hand, and
the control means controls the motor and the drive transmission section so as to correct, when the reception means received the time code, only the second hand and the minute hand to the time instant corresponding to the time code.

3. An analog radio-controlled timepiece according to claim 1, wherein:
it additionally has a date indicator displaying a date, and the rotation drive means is constituted so as to rotation-drive the date indicator in response to a control of the control means, and
the control means controls the rotation drive means so as to alter a displayed date of the date indicator when the hour hand became 24 o'clock by rotation-operating the hour hand by the hour hand operation means.

4. An analog radio-controlled timepiece according to claim 2, wherein:
it additionally has a date indicator displaying a date, and the rotation drive means is constituted so as to rotation-drive the date indicator in response to a control of the control means, and
the control means controls the rotation drive means so as to alter a displayed date of the date indicator when the hour hand became 24 o'clock by rotation-operating the hour hand by the hour hand operation means.

5. An analog radio-controlled timepiece according to claim 1, wherein:
it possesses a date indicator displaying a date, and a detection means detecting the fact that the hour hand became 24 o'clock, and the rotation drive means rotation-drives the second hand, the minute hand, the hour hand and the date indicator, and
the control means controls the rotation drive means so as to perform a date unlocking processing by rotation-driving the date indicator when the detection means detected the fact that the hour hand became 24 o'clock by an operation of the hour hand operation means.

6. An analog radio-controlled timepiece according to claim 5, wherein:
the rotation drive means has a motor means and a drive transmission section for transmitting a rotation of the motor means to the second hand, the minute hand, the hour hand and the date indicator, and
the control means controls the motor means and the drive transmission section so as to correct, when the reception means received the time code, only the second hand and the minute hand to the time instant corresponding to the time code.

7. An analog radio-controlled timepiece according to claim 5, wherein:
the reception means receives information of a year, a date, a minute and a second, which are included in the time code, and
the control means stores the information of the year and the date, which were received by the reception means, to a storage means, and, when the detection means detected the fact that the hour hand became 24 o'clock by the operation of the hour hand operation means, controls the rotation drive means so as to perform the date unlocking processing such that a date display of the date indicator becomes a first day in a case of the end of month by referring to the information of the year and the date, which were stored in the storage means, and adds a day number date-unlocking-processed to the information stored in the storage means.

8. An analog radio-controlled timepiece according to claim 6, wherein:
the reception means receives information of a year, a date, a minute and a second, which are included in the time code, and
the control means stores the information of the year and the date, which were received by the reception means, to a storage means, and, when the detection means detected the fact that the hour hand became 24 o'clock by the operation of the hour hand operation means, controls, the rotation drive means so as to perform the date unlocking processing such that a date display of the date indicator becomes a first day in a case of the end of month by referring to the information of the year and the date, which were stored in the storage means, and adds a day number date-unlocking-processed to the information stored in the storage means.

9. An analog radio-controlled timepiece according to claim 1, wherein:
it possesses a date indicator displaying a date,
the rotation drive means rotation-drives the second hand, the minute hand, the hour hand and the date indicator, and
the control means controls a reception mode selection means selecting one of a first reception mode in which a time instant of the second hand and the minute hand is corrected on the basis of the time code and a second reception mode in which a time of the second hand, the minute hand and the hour hand and the date of the date indicator are corrected on the basis of the time code, and the rotation drive means so as to correct, in the first reception mode, only the second hand and the minute hand to the time instant corresponding to the time code, thereby controlling the rotation drive means so as to correct, in the second reception mode, the second hand, the minute hand, the hour hand and the date indicator to a time and a date, which correspond to the time code.

10. An analog radio-controlled timepiece according to claim 9, wherein:
the rotation drive means has a motor means and a drive transmission section for transmitting a rotation of the motor means to the second hand, the minute hand, the hour hand and the date indicator, and
the hour hand operation means drive-operates the drive transmission section such that only the hour hand rotates.

11. An analog radio-controlled timepiece according to claim 9, wherein the reception mode selection means has an operation means capable of predetermination-operating, and the control means judges, on the basis of an operation of the operation means, which of the first and second reception modes was selected, thereby controlling the rotation drive means so as to perform a processing corresponding to the selected reception mode.

12. An analog radio-controlled timepiece according to claim 10, wherein the reception mode selection means has an operation means capable of predetermination-operating, and the control means judges, on the basis of an operation of the operation means, which of the first and second reception modes was selected, thereby controlling the rotation drive means so as to perform a processing corresponding to the selected reception mode.

13. An analog radio-controlled timepiece according to claim 11, wherein the operation means is constituted by the hour hand operation means, and the control means shifts to the first reception mode in a case where there was detected the fact that a time difference correction was performed by the hour hand operation means, and shifts to the second reception mode in a case where there was detected the fact that the time difference correction was released.

14. An analog radio-controlled timepiece according to claim 12, wherein the operation means is constituted by the hour hand operation means, and the control means shifts to the first reception mode in a case where there was detected the fact that a time difference correction was performed by the hour hand operation means, and shifts to the second reception mode in a case where there was detected the fact that the time difference correction was released.

15. An analog radio-controlled timepiece according to claim 13, wherein:
the hour hand operation means includes a crown and performs the time difference correction of the hour hand by an operation of the crown, and
the control means shifts to the first reception mode in the case where there was detected the fact that the time difference correction was performed by the crown, and shifts to the second reception mode in the case where there was detected the fact that the time difference correction was released.

16. An analog radio-controlled timepiece according to claim 10, wherein:
it has a detection means detecting the fact that the hour hand became 24 o'clock, and
the control means controls the rotation drive means so as to perform a date unlocking processing by rotation-driving the date indicator when the detection means detected the fact that the hour hand became 24 o'clock by an operation of the hour hand operation means.

17. An analog radio-controlled timepiece according to claim 10, wherein the reception means receives, in the first
